(19) United States
(12) Patent Application Publication
(10) Pub. No.: US 2008/0252029 A1
(43) Pub. Date: Oct. 16, 2008

(54) HOCKEY BAG

(76) Inventor: David Orlando Walcott, Montreal (CA)

Correspondence Address: WILDMAN HARROLD ALLEN & DIXON LLP, 225 WEST WACKER DRIVE, SUITE 2800, CHICAGO, IL, 60606, US

(21) Appl. No.: 11/735,844

(22) Filed: Apr. 16, 2007

(51) Int. Cl. B62B 1/00

(52) U.S. Cl. 280/47.131; 190/18 A; 206/315.1; 224/191; 29/428

(57) ABSTRACT

A bag for carrying at least one hockey stick and at least one other item, the bag having an enclosure adapted to transport the at least one other item and at least a first closable opening in the enclosure to insert the at least one other item therein. A hockey stick pocket is located on and integral with an outer surface of the enclosure and is composed of a straight elongated section connected to a head section at an angle so as to mimic the shape of the at least one hockey stick. The hockey stick pocket has at least a second closable opening so as to allow insertion of the at least one hockey stick therein.

### FIELD OF THE INVENTION

The present invention relates to bags adapted to carry miscellaneous objects, and more particularly to sports bags adapted to carry one or more hockey sticks.

### BACKGROUND OF THE INVENTION

People performing athletic activities are generally required to transport clothing and/or equipment when the activities are performed out of their homes. Particularly, hockey players often need to transport a large quantity of equipment, such as protective gear, articles of clothing, pucks, and one or more hockey sticks. While most of the equipment can be fitted into standard hockey sports bags, the hockey sticks have a cumbersome shape which cannot be fitted into such bags.

Canadian application No. 2,236,909 by Hincher discloses a bag having a hockey stick shape to transport hockey sticks more easily. Although this bag is provided with small pockets to transport miscellaneous items, it cannot be used to transport equipment such as protective gear. The hockey player must therefore transport both a standard hockey bag and this hockey stick bag.

Canadian application No. 2,127,038 by Greco et al. teaches a hockey stick bag detachably connected to a sports bag. This connection is made through a pair of spaced apart strips on the hockey stick bag, each being designed to engage a strap of the sports bag. The disadvantage of this connection is that a difference in distance between the straps and the strips, or a different strap configuration, can prevent the hockey stick bag from being successfully engaged to the sports bag.

Accordingly, there is a need for a bag that can integrally transport at least one hockey stick together with miscellaneous sports equipment.

### SUMMARY

In one example, a bag for carrying at least one hockey stick and at least one other item is provided. The bag comprising an enclosure adapted to transport the at least one other item, at least a first closable opening in the enclosure to insert the at least one other item therein, a hockey stick pocket located on and integral with an outer surface of the enclosure, the pocket being composed of a straight elongated section connected to a head section at an angle so as to mimic the shape of the at least one hockey stick, and at least a second closable opening in the hockey stick pocket so as to allow insertion of the at least one hockey stick therein.

In another example, a method for carrying a hockey stick is provided comprising the steps of: providing a bag comprising a pocket having a hockey stick shape; inserting the hockey stick within the pocket; and carrying the bag.

Further in accordance with the present invention, there is provided a method for manufacturing a bag for carrying a hockey stick, the method comprising the steps of attaching together a first plurality of panels so as to define an enclosure, providing a first closable opening in the enclosure, attaching together a second plurality of panels so as to define an envelope having the shape of a hockey stick, providing a second closable opening in the envelope so that a hockey stick can be inserted therein, and permanently attaching the envelope onto an outer surface of the enclosure.

### BRIEF DESCRIPTION OF THE DRAWINGS

FIG. 1 is a perspective view of an exemplary hockey bag;

FIG. 2 is a side view of the hockey bag of FIG. 1;

FIG. 3 is a partial cross-section of FIG. 2 taken along line 3-3; and

FIG. 4 is a perspective view of an alternative example of a hockey bag.

### DETAILED DESCRIPTION

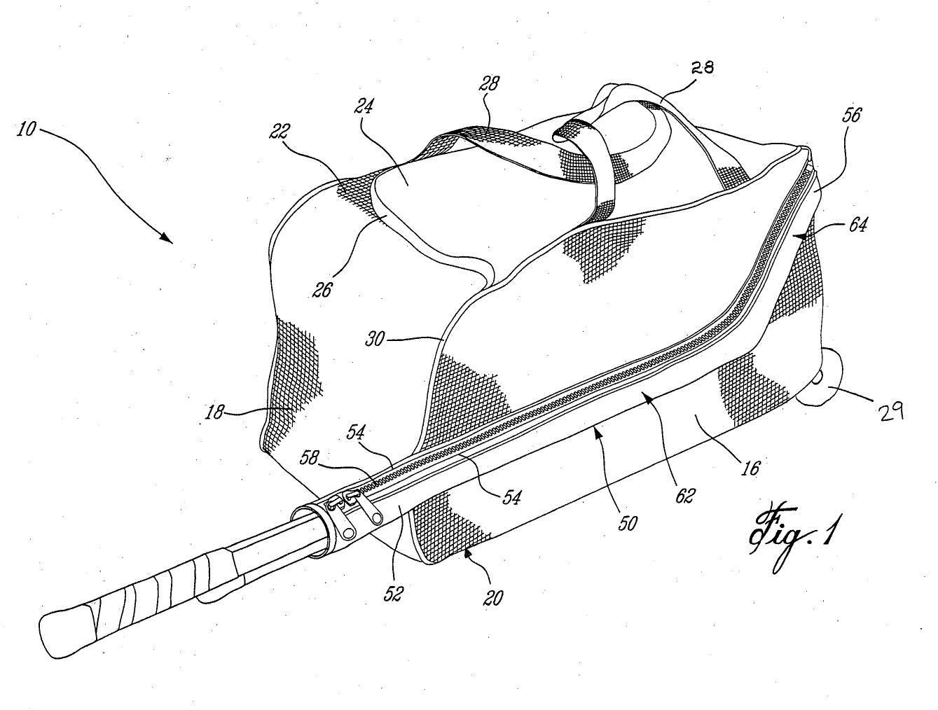

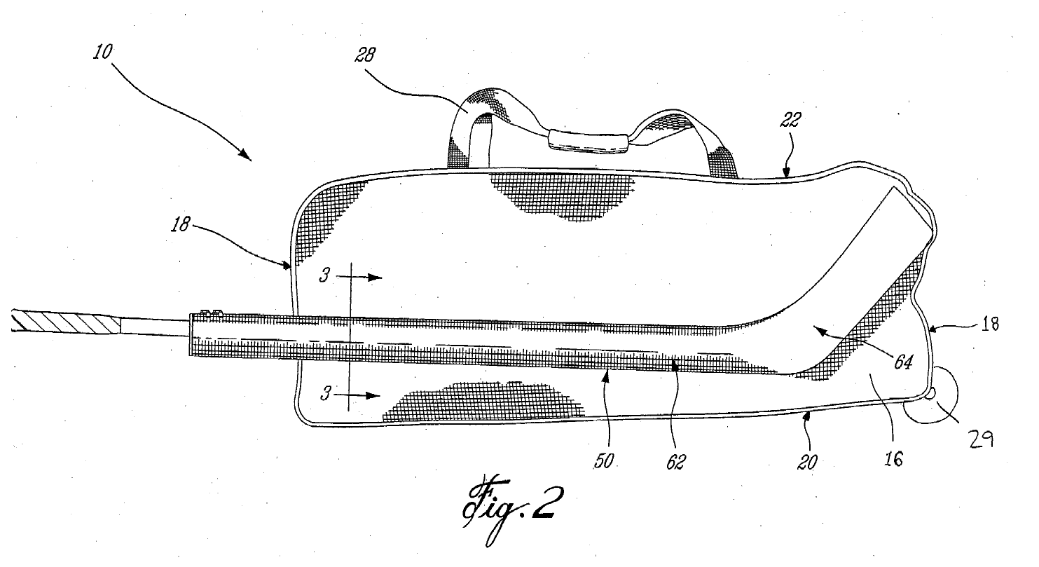

Referring now to FIGS. 1-2, an exemplary hockey bag generally shown at 10 comprises an enclosure formed by two side walls 16, two end walls 18, a bottom wall 20 and a top wall 22. The side walls 16, bottom wall 20 and top wall 22 are preferably elongated so as to define an enclosure having dimensions generally corresponding to standard hockey bags. In the example shown, the end walls 18 and top wall 22 are formed in a single integral panel which is stitched along seams 30 to each of the side walls 16 as well as to the bottom wall 20. It is also considered to have each wall formed by an independent panel with adjacent walls sewn or equivalently attached together. Other combinations of adjacent walls into a single panel are also considered.

A detachable flap 24 is included in the top wall 22 so as to provide a closable opening in the enclosure to insert items therein. The detachable flap 24 may have part of its perimeter integral with the top wall 22 and the rest of its perimeter attachable and detachable with the corresponding opening perimeter through a zipper 26 or any other suitable fastening means. The detachable flap 24 could also be located in one of the side walls 16 or one of the end walls 18 with or instead of in the top wall 22.

A pair of handles 28 are connected to the top wall 22 so as to facilitate carrying of the bag. Handles 28 need to be attached solidly enough so as to be able to bear the normal weight of equipment that will be carried in bag 10.

In this example, a pair of wheels 29 are set at the junction of one end wall 18 and the bottom wall 20. The opposed end of the bag can thus be lifted and the bag rolled on the wheels 29 to facilitate transport.

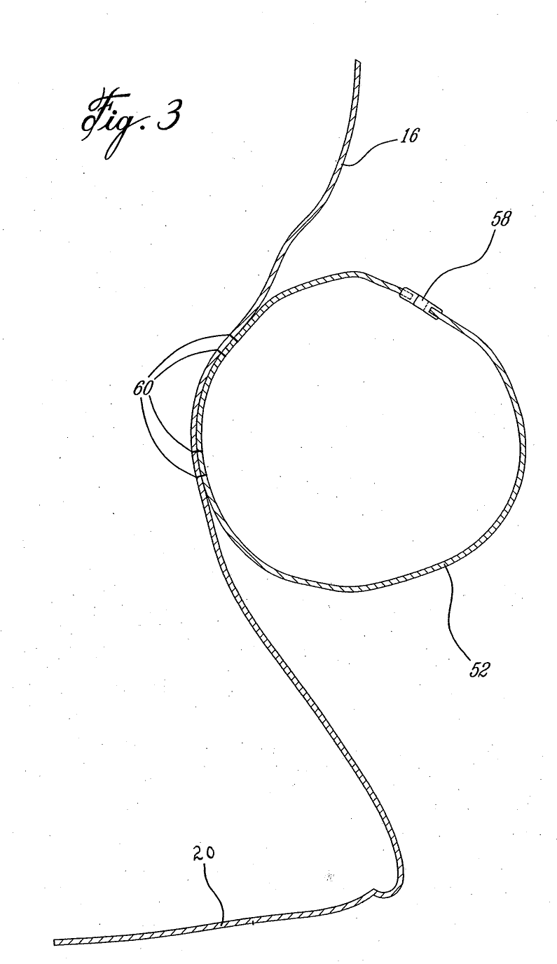

A hockey stick pocket 50 is provided on one of the side walls 16. The hockey stick pocket 50 comprises a side panel 52 which has a generally U-shape section with two longitudinal edges 54. The longitudinal edges 54 are attached together through a zipper 58 or any other suitable fastening means so as to provide a closable opening in the pocket 50. The side panel 52 is shaped so as to form an elongated section 62 connected to a head section 64 at an angle chosen to mimic the shape of a hockey stick. A tip panel 56 closes the end of the U-shape in the side panel 52 at the distal end of the head section 64, while the proximal end of the elongated section 62 remains open. As seen in FIG. 3, the side panel 52 of the pocket 50 is permanently attached to the side wall 16, with the elongated section 62 extending along the length thereof, through a plurality of stitches 60 or any other equivalent attaching means. The head section 64 is located in proximity to the bag end that includes the wheels 29. The hockey stick pocket 50 is therefore adapted to snuggly enclose one or many hockey sticks, the head of each stick being located in the head section 64 and the tip of each stick protruding from the pocket 50 through the open proximal end of the elongated section 62.

A plurality of objects such as clothing articles and protective gear can therefore be carried in the bag enclosure after having been inserted through the opening defined by the zipper 26, while one or many hockey sticks can be carried simultaneously in the hockey stick pocket 50 after having been inserted through the opening defined by the zipper 58.

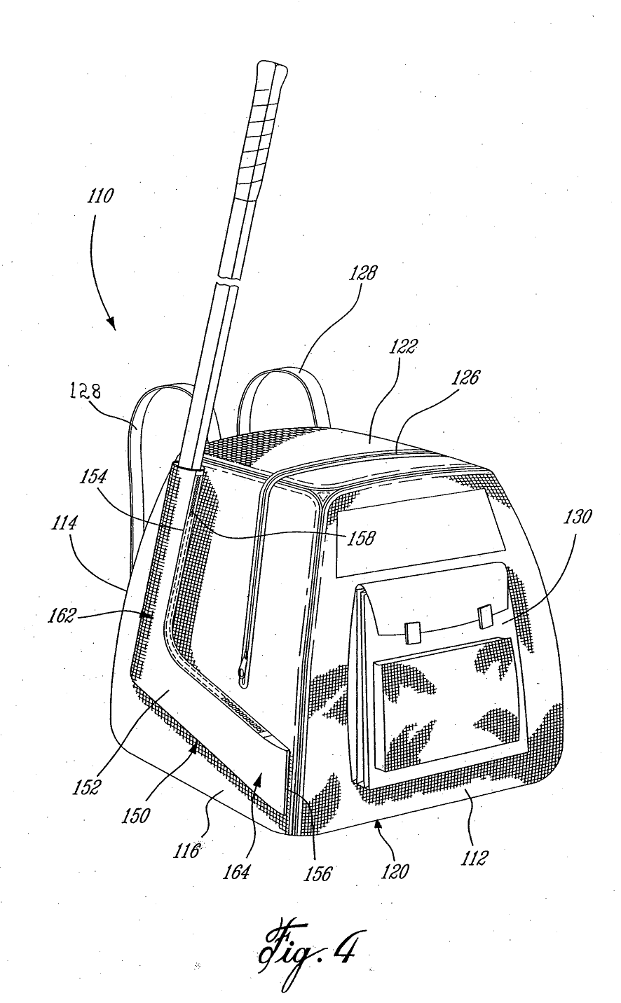

Referring to FIG. 4, an alternative embodiment of the present invention is shown. A bag generally indicated at 110 is a backpack-type bag that includes a front wall 112, a rear wall 114, two side walls 116, a bottom wall 120 and a top wall 122 connected to one another in order to define an enclosure in a manner similar to that described in the previous embodiment. One or a plurality of pockets 130 can be provided along an outer surface of the bag walls.

An opening, closed by a zipper 126, is provided across the top wall 122 and partially extends through both side walls 116 so as to be able to insert items into the enclosure. A pair of straps 128 are connected to the rear wall 114 so as to be able to easily transport the bag 110.

A hockey stick pocket 150 is provided on one of the side walls 116. Similar to the previous embodiment, the pocket 150 includes a side panel having longitudinal edges attached together by a zipper 158 so as to define an elongated section 162 and a head section 164 together representing the shape of a hockey stick. A tip panel 156 closes the distal end of the head section 164 while the proximal end of the elongated section 162 remains open. However, the elongated section 162 is much shorter than the elongated section 62 of the previous embodiment. The hockey stick pocket 150 is permanently attached to the side wall with the elongated section 162 extending along the height thereof, so that the head section 164 is in proximity to the bottom wall 120. The hockey stick pocket 150 is thus adapted to snuggly enclose one or many hockey sticks, the head of each stick being located in the head section 164 and the tip of each stick protruding upwards from the pocket 150 through the open proximal end of the elongated section 162.

It will be appreciated that the invention is not limited to the specific embodiments described, which are merely illustrative. Modifications and variations will be readily apparent to those skilled in the art. For example, the side panel 52, 152 of the hockey stick pocket 50, 150 can be made from two different panels each having one longitudinal edge 54, 154 attached to the zipper 58, 158 and another longitudinal edge stitched to the side wall 16, 116 of the bag 10, 110 so that part of the outer surface of the side wall 16, 116 is included in the enclosure of the pocket 50, 150. Also, the zipper 58, 158 of the pocket 50, 150 can be located along the head section 64, 164 or elsewhere, as long as hockey sticks can be easily inserted in the pocket 50,150.

Accordingly, the scope of the invention is deemed to be in accordance with the claims as set forth below.

What is claimed is:

1. A bag for carrying at least one hockey stick and at least one other item, the bag comprising:
an enclosure adapted to transport the at least one other item;
at least a first closable opening in the enclosure to insert the at least one other item therein;
a hockey stick pocket located on and integral with an outer surface of the enclosure, the pocket being composed of a straight elongated section connected to a head section at an angle so as to mimic the shape of the at least one hockey stick; and
at least a second closable opening in the hockey stick pocket so as to allow insertion of the at least one hockey stick therein.

2. The bag according to claim 1, wherein the elongated section has an open proximal end so that at least a handle of the hockey stick protrudes by the open proximal end when the hockey stick is inserted in the hockey stick pocket.

3. The bag according to claim 1, wherein the at least one item includes hockey protective gear.

4. The bag according to claim 1, wherein the hockey stick pocket snuggly encloses the at least one hockey stick therein.

5. The bag according to claim 1, wherein the bag has a length larger than a width, and the pocket extends along the length of the bag.

6. The bag according to claim 1, wherein the bag is a backpack-type bag, and the pocket extends along a height of the bag.

7. The bag according to claim 1, wherein the second closable opening is defined in the elongated section and the head section such as to extend along an entire length of the pocket.

8. The bag according to claim 1, wherein the second closable opening is defined in the head section only.

9. The bag according to claim 1, wherein the outer surface of the enclosure defines a bottom surface including at least two wheels, the wheels being generally concentric and axially spaced apart.

10. A method for carrying a hockey stick, the method comprising the steps of:
providing a bag comprising a pocket having a hockey stick shape;
inserting the hockey stick within the pocket; and
carrying the bag.

11. The method according to claim 10, wherein the bag includes an enclosure and the method further comprises a step of inserting hockey equipment into the enclosure before carrying the bag.

12. A method for manufacturing a bag for carrying a hockey stick, the method comprising the steps of:
attaching together a first plurality of panels so as to define an enclosure;
providing a first closable opening in the enclosure;
attaching together a second plurality of panels so as to define an envelope having the shape of a hockey stick;
providing a second closable opening in the envelope so that a hockey stick can be inserted therein; and
permanently attaching the envelope onto an outer surface of the enclosure.
